(19) United States
(12) Patent Application Publication
(10) Pub. No.: US 2020/0083990 A1
(43) Pub. Date: Mar. 12, 2020

(54) Methods, Apparatus and Machine-Readable Mediums for Generation and Transmission of a Message in a Wireless Communications Network

(71) Applicant: Telefonaktiebolaget LM Ericsson (publ), Stockholm (SE)

(72) Inventors: Oskar Mauritz, Johanneshov (SE); Tomas Lagerqvist, Stockholm (SE); Stefan Parkvall, Bromma (SE)

(21) Appl. No.: 16/305,215

(22) PCT Filed: May 3, 2018
(86) PCT No.: PCT/SE2018/050461

§ 371 Date: Nov. 28, 2018

(51) Int. Cl. H04L 1/18; H04L 1/00

(52) U.S. Cl. CPC H04L 1/1822; H04L 1/0057; H04L 1/1861; H04L 1/0067; H04L 1/1819

(57) ABSTRACT

The disclosure provides methods, apparatus and machine-readable mediums for generating and transmitting a message in a wireless communications network. One embodiment provides a method in a transmitting node. The method comprises: processing a block of data to generate a message for transmission by the transmitting node; and transmitting the message. Processing the block of data comprises: performing a scrambling algorithm on data using a scrambling code; and, subsequent to performing the scrambling algorithm, performing a rate-matching algorithm to match a number of bits for transmission to radio resources available to the transmitting node.

### TECHNICAL FIELD

Embodiments of the present disclosure relate to wireless communication, and particularly to methods, apparatus and machine-readable mediums for low-latency transmissions in a wireless communications network.

### BACKGROUND

In a wireless communications network, such as evolved universal terrestrial radio access network (E-UTRAN) or the networks being developed to meet the requirements set out for the fifth generation (5G) of wireless systems as defined by the Next Generation Mobile Networks Alliance (often referred to as “New Radio”, or NR), low latency is important for many applications, e.g., mobile broadband, remote control of machinery, etc.

In E-UTRA downlink latency is due to several factors, such as processing for scheduling and transport block processing. E-UTRA applies hybrid automatic repeat request (HARQ) so that if a UE fails to receive a transmitted packet, the eNB can retransmit the packet one or several times, and the UE can combine the transmitted packets to increase the probability for successful reception. The HARQ process is shown in FIGS. 1 and 2. FIG. 1 shows successful transmission and receipt of a transport block. Thus, the UE receives the transport block and, as it is successfully decoded, transmits an acknowledgment (ACK) to the eNB. FIG. 2 shows unsuccessful transmission and receipt of a transport block. If the UE receives but fails to decode the transport block, it instead transmits a negative acknowledgment (NACK) to the eNB. If the eNB receives a negative acknowledgment it will retransmit the transport block. Similarly, if the eNB receives no acknowledgement at all from the UE, it will retransmit the transport block.

It can be seen that the HARQ process adds considerable latency to the transmission of a packet, and that part of that latency is caused by the time taken to prepare the transmission (whether successfully received or not) and the retransmission (if the initial transmission is not successfully received). If the time taken to prepare the transmission and the retransmission can be reduced, the latency of the transmission can be similarly reduced. Indeed, if the time taken to prepare any transmission can be reduced, latency can be reduced for any transmission.

### SUMMARY

FIG. 3 shows in more detail the processing of a transport block of information bits for downlink data in E-UTRA is processed for transmission, e.g. in a physical layer of an eNB. It can be seen that data is processed in the following order (see 3GPP TS 36.212, v9.3.0, section 5.3.2; and 3GPP TS 36.211, v9.1.0, section 6.3):
Transport block cyclic redundancy check (CRC) attachment (step 300)
Code block segmentation and code block CRC attachment (step 302)
Channel coding (step 304)
Rate matching (step 308)
Code block concatenation (step 310)
Scrambling (step 312)
Modulation (step 314)
Layer mapping (step 316)
Precoding (step 318)
Mapping to resource elements (step 320)
Orthogonal frequency-division multiplexing (OFDM) signal generation (step 322)

Once the data has been channel coded (i.e. after step 304), the data may optionally be stored in a memory which is local to the eNB or otherwise accessible by the eNB (step 306).

The corresponding flow chart for retransmission (i.e. processing a transport block for transmission when a previous transport block has not been received correctly) is shown in FIG. 4. Steps for transport block CRC attachment, code block segmentation and code block CRC attachment, and channel coding in respect of the retransmission may be identical to steps 300, 302 and 304 for the initial transmission and need not be repeated if the result of step 304 for the initial transmission, i.e. the channel coded bits, is stored in memory. In the illustrated example, the channel encoded data is loaded from memory (step 400).

The process of rate-matching, in step 402, matches the coded bits from step 400 to the amount of radio resources (i.e. frequencies, time slots and/or orthogonal transmission codes) available for transmission. If the amount of resources is the same or greater for the retransmission as for the initial transmission, steps 402 and 404 (concatenation of code blocks) are also identical to steps 308 and 310, and the concatenated bits from the first transmission, if saved from the initial transmission, can be reused for the processing for the retransmission. However, if the amount of resources differs or if the redundancy version differs (which affects rate matching) between the initial transmission and the retransmission, steps 402 and 404 must be processed anew for the retransmission.

The scrambling algorithm (i.e. as performed in step 6 for both transmission and retransmission) in E-UTRA depends on the slot number (see 3GPP TS 36.211, v9.1.0, section 6.3), and therefore steps of scrambling (step 406), modulation (step 408), mapping to layers (step 410), precoding (step 412), mapping to resource elements (step 414) and OFDM signal generation (step 416) must always be processed again for the retransmission as the slot number of the retransmission will generally be different to that of the original transmission.

Every step in the processing of transport blocks for transmission can increase latency between the decision to transmit (e.g. because of a received NACK message) and the actual transmission of the information. In the context of the HARQ process, if the amount of resources for transmission changes between initial transmission and retransmission, not only rate matching but also scrambling must be performed again.

In order to address these and other problems, the disclosure provides methods, apparatus and machine-readable mediums as set out in the summary and detailed description below.

One aspect of the disclosure provides a method in a transmitting node, the transmitting node operative in a wireless communications network. The method comprises: processing a block of data to generate a message for transmission by the transmitting node; and transmitting the message. Processing the block of data comprises: performing a scrambling algorithm on data using a scrambling code; and subsequent to performing the scrambling algorithm, performing a rate-matching algorithm to match a number of bits for transmission to radio resources available to the transmitting node.

In another aspect, there is provided a method in a transmitting node, the transmitting node operative in a wireless communications network. The method comprises: generating a first message for transmission by the transmitting node; transmitting the first message; responsive to a determination that a re-transmission is required in relation to the first message, generating a second message for transmission by the transmitting node; and transmitting the second message. Generating the first message comprises: performing a scrambling algorithm on data using a scrambling code; and storing data on which the scrambling algorithm has been performed. Generating the second message comprises: generating the second message based on the stored data.

Apparatus and machine-readable mediums corresponding to the methods set out above are also provided.

### BRIEF DESCRIPTION OF THE DRAWINGS

For a better understanding of the present disclosure, and to show how it may be put into effect, reference will now be made, by way of example, to the accompanying drawings, in which:

FIG. 1 is a signalling diagram showing the successful transmission of a message according to the HARQ process;

FIG. 2 is a signalling diagram showing the unsuccessful transmission of a message according to the HARQ process;

FIG. 3 is a flowchart of a method of processing a transport block for transmission;

FIG. 4 is a flowchart of a method of processing a transport block for re-transmission;

FIG. 5 is a flowchart of a method of processing a transport block for transmission according to embodiments of the disclosure;

FIG. 6 is a flowchart of a method of processing a transport block for re-transmission according to embodiments of the disclosure;

FIG. 7 is a schematic drawing of a transmitting node according to embodiments of the disclosure; and

FIG. 8 is a schematic drawing of a transmitting node according to further embodiments of the disclosure.

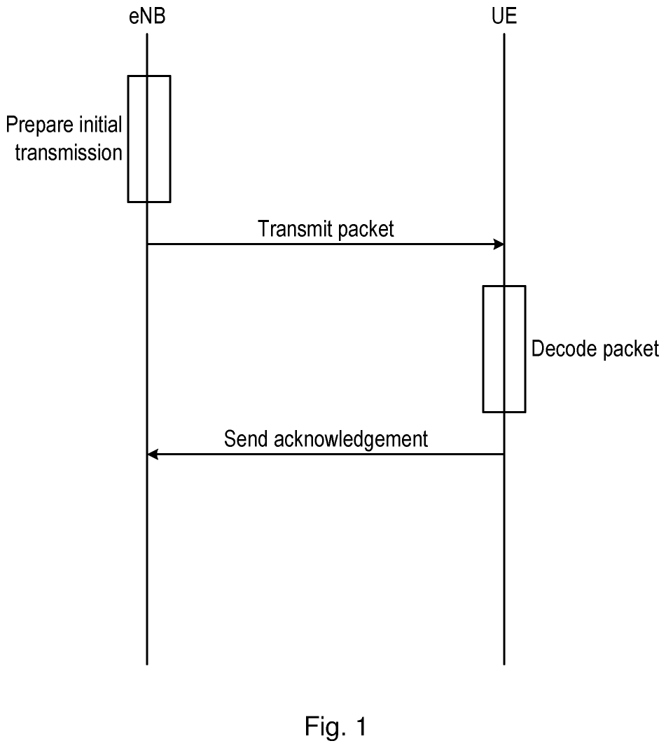

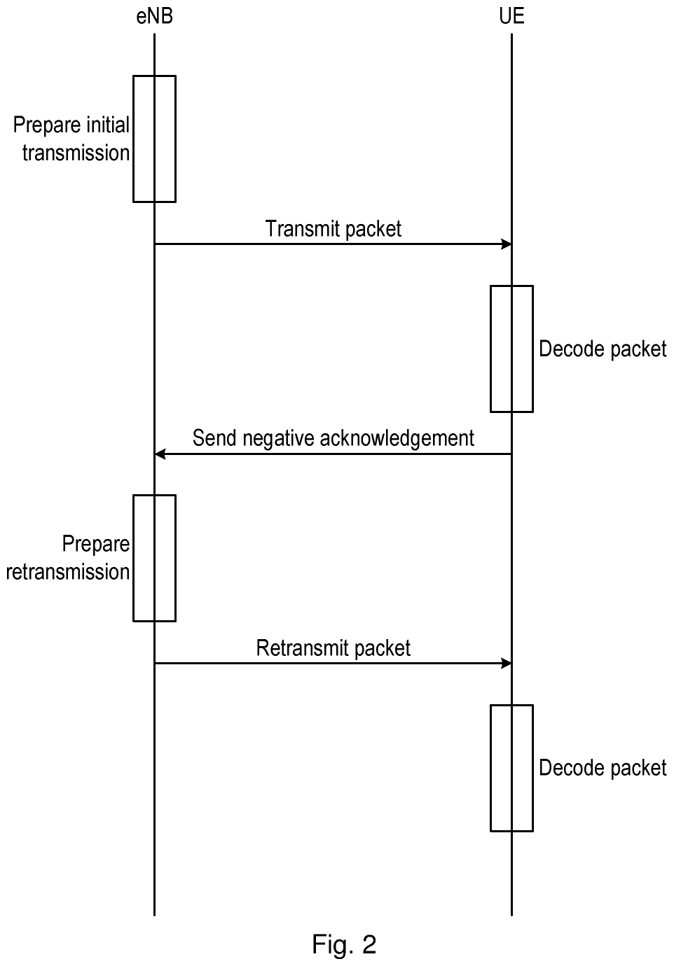

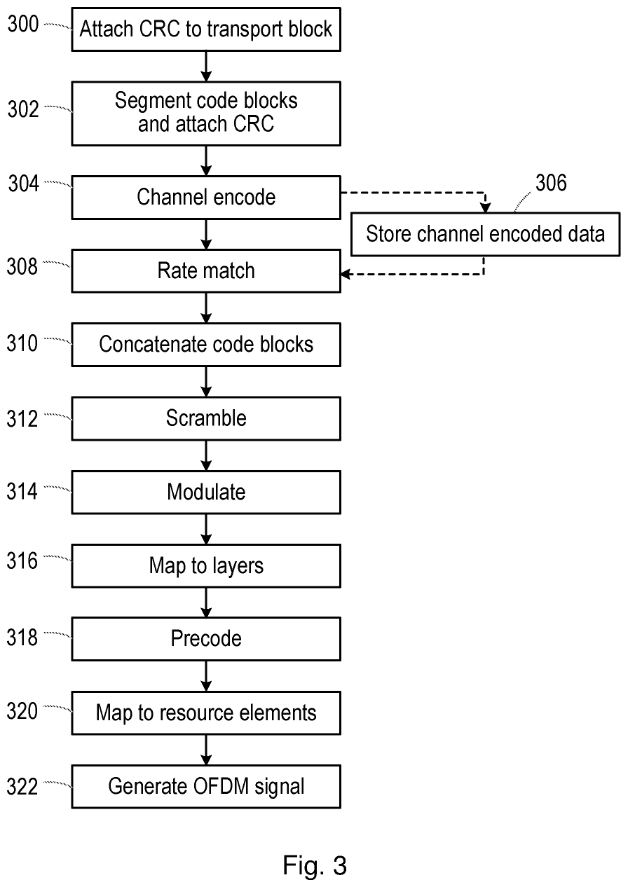

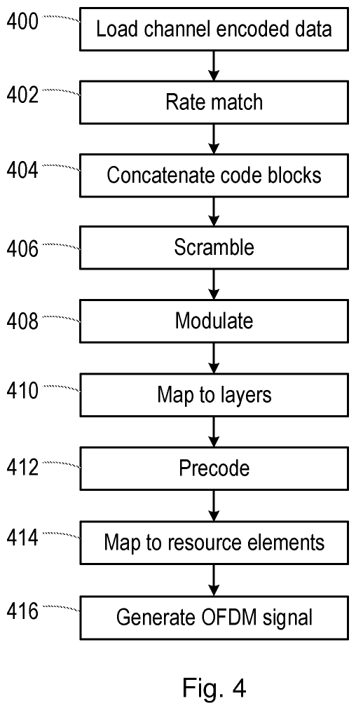

### DETAILED DESCRIPTION

The following sets forth specific details, such as particular embodiments for purposes of explanation and not limitation. But it will be appreciated by one skilled in the art that other embodiments may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Although the description is given for a wireless terminal device, or user equipment (UE), it should be understood by the skilled in the art that “UE” is a non-limiting term comprising any mobile or wireless device, terminal or node equipped with a radio interface allowing for at least one of: transmitting signals in uplink (UL) and receiving and/or measuring signals in downlink (DL). A UE herein may comprise a UE (in its general sense) capable of operating or at least performing measurements in one or more frequencies, carrier frequencies, component carriers or frequency bands. It may be a “UE” operating in single- or multi-radio access technology (RAT) or multi-standard mode. As well as “UE”, the terms “mobile station” (“MS”), “mobile device”, “terminal device” and “wireless terminal device” may be used interchangeably in the following description, and it will be appreciated that such a device does not necessarily have to be ‘mobile’ in the sense that it is carried by a user. Examples of UE are target device, device to device (D2D) UE, machine type UE or UE capable of machine to machine (M2M) communication, PDA, tablet computer, mobile terminals, smart phone, laptop embedded equipped (LEE), laptop mounted equipment (LME), USB dongles, ProSe UE, V2V UE, V2X UE, MTC UE, eMTC UE, FeMTC UE, UE Cat 0, UE Cat M1, narrowband Internet of Things (NB-IoT) UE, UE Cat NB1, etc.

In some embodiments a term “network node” is used and it can correspond to any type of radio access node or any network node, which communicates with a UE and/or with another network node. Examples of network nodes are NodeB, MeNB, SeNB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc.), O&M, OSS, SON, positioning node (e.g. E-SMLC), MDT, test equipment, etc. Moreover, where the following description refers to steps taken in or by a network node or a radio access node, this also includes the possibility that some or all of the processing and/or decision making steps may be performed in a device that is physically separate from the radio antenna of the node, but is logically connected thereto. Thus, where processing and/or decision making is carried out “in the cloud”, the relevant processing device is considered to be part of the node for these purposes.

A “node” is defined as any network node or wireless terminal device, as defined above.

The embodiments are described for LTE or LTE based systems such as machine-type communication (MTC), evolved MTC (eMTC), NB-IoT etc. As an example MTC UE, eMTC UE and NB-IoT UE also called UE category 0, UE category M1 and UE category NB1. However, the embodiments are applicable to any RAT or multi-RAT systems, where the UE receives and/or transmit signals (e.g. data) e.g. LTE FDD/TDD, WCDMA/HSPA, GSM/GERAN, Wi-Fi, WLAN, CDMA2000, 5G, NR, etc. It is recalled that 5G, the fifth generation of mobile telecommunications and wireless technology is not yet fully defined but in an advanced draft stage within 3GPP. It includes work on 5G New Radio (NR) Access Technology. LTE terminology is used in this disclosure in a forward looking sense, to include equivalent 5G entities or functionalities although a different term is specified in 5G. A general description of the agreements on 5G New Radio (NR) Access Technology so far is contained in most recent versions of the 3GPP 38-series Technical Reports.

According to embodiments of the disclosure, when processing a block of data to generate a message for transmission, a node in a network performs a scrambling algorithm on the data, and subsequently performs rate-matching algorithm on the data on which the scrambling algorithm has been performed.

The scrambling algorithm may utilize a scrambling code which is time-independent (i.e. does not change with time, or is a constant persistently or semi-persistently). In this way, once the scrambling algorithm has been carried out, the scrambled data can be stored in a machine-readable medium which is local to the node, or otherwise accessible to the node. When a decision is made to transmit the data, the processing of the data to generate the message for transmission can be resumed from the stored data, rather than afresh. Thus latency is reduced in the transmission as the scrambling algorithm does not need to be carried out again.

In further embodiments of the disclosure, the node may store data to which more algorithms have been applied and, if conditions remain the same between the time at which the algorithms are performed and the time at which the message is transmitted, the processing of the data can resume from that stored data. For example, if the radio resources available to the node remain the same (or more resources are available to the node than previously), the node may store data to which both the scrambling algorithm and the rate-matching algorithm have been applied, and resume from that data when a decision is taken to transmit. Thus in that embodiment latency is reduced corresponding to the time taken to perform the scrambling and rate-matching algorithms.

Embodiments of the disclosure may be useful in any situation in which data can be prepared for transmission in advance of the decision to actually transmit.

For example, embodiments of the disclosure may relate to HARQ or other similar systems, in which a first packet is transmitted but not successfully received by a receiving node (e.g., a negative acknowledgement message is received, or no acknowledgement message is received at all). In those circumstances, the transmitting node may store data at one or more steps while processing a transport block to generate the first message for transmission, and then reuse that stored data when processing data to generate a second message (i.e. a retransmission).

In another example, embodiments of the disclosure may relate to communications systems, such as licensed assisted access (LAA), in which a “listen before talk” (also known as “listen before transmit”) condition applies. In those circumstances, a transmitting node must sense its radio environment (or a particular radio channel) to determine whether the radio environment or radio channel is available (i.e. no other node is transmitting), before transmitting. Thus, in those circumstances, the transmitting node may store data at one or more steps while processing a transport block to generate a message for transmission, wait until the radio environment or radio channel is available, and then reuse that stored data to generate and transmit the message when the environment or channel becomes available.

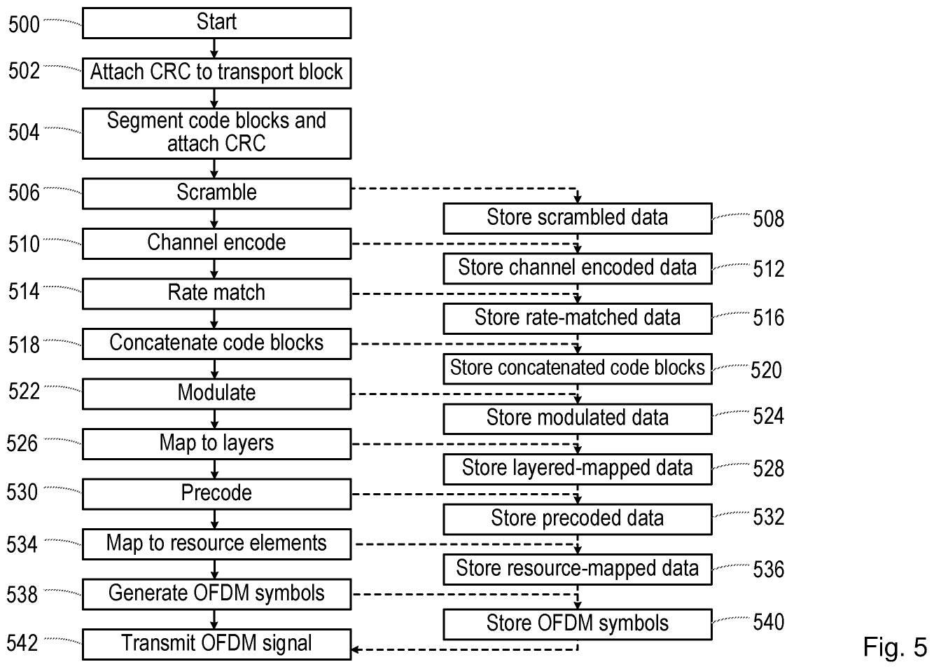

FIG. 5 is a flowchart of a method according to embodiments of the disclosure. The method may be carried out in a node of a wireless communications network, such a wireless terminal device (i.e. when transmitting in uplink or sidelink), or a radio access node (i.e. when transmitting in downlink).

The node may implement a protocol stack comprising a plurality of layers. In such an embodiment, the method may be carried out in a physical or lowermost layer of the protocol stack.

The method begins in step 500. The node or physical layer may receive a transport block comprising a block of data (i.e. a plurality of bits) which is to be transmitted by the node. The transport block may be received from a media access control (MAC) layer of the protocol stack, for example.

Error detection may be provided for the data through a cyclic redundancy check (CRC). In step 502, therefore, the node determines one or more CRC parity bits and attaches those parity bits to the transport block. For example, the parity bits may be determined by executing a cyclic generator polynomial on the bits of the transport block. Those skilled in the art understand such an operation and this is not described in further detail herein. If further detail is required, the reader is directed to 3GPP TS 36.212, v9.3.0, section 5.11 and 5.3.2. The parity bits may be attached to the transport block by appending the parity bits to the end of the transport block.

In step 504, if the number of bits output from step 502 is greater than a maximum code block size, the node segments the data into two or more code blocks. Filler bits may be added to one or more of the code blocks to ensure each code block is the same size. An additional CRC parity bit sequence may be attached to each of the code blocks so formed.

In step 506, a scrambling algorithm is carried out on the data which is output from step 504, using a scrambling code. For example, the data may be scrambled by executing a bitwise exclusive or operation on the data with the scrambling code, or determining for the ith bit of the scrambled data, the value of (aᵢ+bᵢ)modulo2, where aᵢ is the data to be scrambled, and bᵢ is the scrambling code. Other scrambling mechanisms are also possible, and the present disclosure is not limited in this respect.

The scrambling code or sequence may be a pseudo random number generated by the node using any suitable pseudo random number generator, such as a Gold sequence. The pseudo random number generator may be initialized based on one or more parameters. For example the one or more parameters may include one or more of: an identity of the transmitting node (such as a radio network temporary identifier, RNTI); a number of layers over which the message is transmitted; an identity of a cell by which the node is served, or which the node is serving; and an identifier associated with a physical channel over which the message is transmitted. In some embodiments, each of the parameters on which the pseudo random number generator is initialized may be time-independent or substantially time-independent, and thus the scrambling code itself may be time-independent or substantially time-independent.

It will be understood by those skilled in the art that a parameter being time-independent or substantially time-independent does not preclude the parameter changing at any point in time. For example, it is common in the field of wireless communications networks for parameters to be defined persistently or semi-persistently. In the former case, parameters may be defined until further notice, i.e. until another node of the network informs the node that the value of the parameter has changed. In the latter case, the parameters may be defined for a defined time window or for a defined duration. Nonetheless, such parameters (and scrambling codes) may be considered time-independent as defined herein. As will be seen from the following description, it suffices if the scrambling code does not change from the point at which step 506 is carried out, to the point that the ensuing signal is transmitted (or retransmitted).

In step 508, the scrambled data (i.e. the output of step 506) is optionally stored in a memory or other machine-readable medium which is local to the node or accessible by it.

Continuing to step 510, a channel encoding algorithm is performed on the scrambled data (i.e. the output of step 506). A number of channel encoding algorithms will be known to those skilled in the art and the present disclosure is not limited in this respect. Some examples of suitable encoding mechanisms include turbo encoding and convolutional coding (such as tail biting convolutional coding). The encoding mechanism may utilize a forward error correcting code.

In step 512, the channel-encoded data (i.e. the output of step 510) is optionally stored in the memory which is local to the node or otherwise accessible by it.

In step 514, the node performs a rate-matching algorithm on the channel-encoded data (i.e. the output of step 510). The purpose of the rate-matching algorithm is to match the bits for transmission to the available resources for transmission. For example, the node may be a wireless terminal device (i.e. a UE) and require scheduling of radio resources (i.e. frequencies, time slots and/or orthogonal codes) for transmission in the uplink or sidelink. Alternatively, the node may be a radio access node serving multiple terminal devices. In either case, the resources available to the node for each transmission are limited and may vary with time. The rate-matching algorithm thus matches the bits output from step 510 to the available resources.

The rate-matching algorithm may implement a buffer, such as a circular buffer, into which the output of step 510 is stored, and from which bits are selected to populate blocks of bits for transmission.

In step 516 the rate-matched data (i.e. the output of step 514) is optionally stored in the memory which is local to the node or otherwise accessible by it.

In step 518, if the output of the rate-matching algorithm has generated more than one code block, these code blocks are concatenated. For example, the code blocks may be sequentially concatenated.

In step 520, the concatenated data (i.e. the output of step 518) is optionally stored in the memory which is local to the node or otherwise accessible by it.

In step 522, a modulation algorithm is performed on the code block(s), i.e. the output of step 518. For example, the code block(s) may be modulated according to a particular modulation scheme, or a modulation scheme selected from a plurality of available modulation schemes. Some examples of suitable modulation schemes include quadrature phase shift keying (QPSK), 16 quadrature amplitude modulation, and 64 quadrature amplitude modulation. Higher-order modulation schemes may become possible in future and the present disclosure is not limited in this respect. Thus the output of step 522 is a block of complex-valued symbols.

In step 524, the modulated data (i.e. the output of step 522) is optionally stored in the memory which is local to the node or otherwise accessible by it.

In step 526, the modulated symbols are optionally mapped to one or more layers (i.e. independent data streams) for transmission by the node. Those skilled in the art will be familiar with the use of multi-input-multi-output (MIMO) antenna systems for the simultaneous transmission of multiple independent data streams, or layers, from the node. However, the concepts disclosed herein do not require MIMO systems, and may relate to the transmission of a single layer whether or not a MIMO system is employed.

In step 528, the layer-mapped data or symbols (i.e. the output of step 526) are optionally stored in the memory which is local to the node or otherwise accessible by it.

In step 530, the layer-mapped data is subject to a precoding algorithm by the node. For example, the node may apply a precoding matrix or vector, selected from a codebook of such precoding matrices or vectors. Step 530 may be dependent on the presence of multiple independent data streams or layers, and therefore this step may be optional, and appropriate for MIMO systems. Precoding is well known in the art and will not be described in detail herein.

In step 532, the precoded data (i.e. the output of step 530) is optionally stored in the memory which is local to the node or otherwise accessible by it.

In step 534, the precoded data (i.e. the output of step 530) is mapped to physical resources within the radio resources that are available to the node for transmission. For example, the symbols may be mapped to resource elements such as physical resources blocks which are available to the node (i.e. have been scheduled to the node or available for transmission by the node). Numerous algorithms for performing such mapping are known in the art and the present disclosure is not limited in that respect. For example, the mapping algorithm may take into account resource elements which are reserved for other functions than transmitting data, such as reference signals or sounding reference signals.

In step 536, the mapped data (i.e. the output of step 534) is optionally stored in the memory which is local to the node or otherwise accessible by it.

In step 538, one or more orthogonal frequency division multiplexed (OFDM) symbols are generated based on the mapped data (i.e. the output of step 534). This process is well understood by those skilled in the art and will not be described further herein.

In step 540, the OFDM symbols (i.e. the output of step 538) are optionally stored in the memory which is local to the node or otherwise accessible by it.

In step 542, the OFDM symbols are transmitted by transmission circuitry of the node (i.e. via one or more antennas and associated transceiver circuitry).

Thus FIG. 5 sets out a method according to which a transport block is processed for transmission by a node for a wireless communications network. The method sets out a series of steps, in which a scrambling algorithm is applied prior to a rate-matching algorithm. At each or any stage of processing, the processed data may be stored in a memory or other machine-readable medium which is accessible by the node, and thus the method may allow the early processing of a transport block, before a decision has been taken to transmit or before the time and/or resources of the transmission are known to the node.

For example, the method may be useful when processing and transmitting packets according to the HARQ process or other similar acknowledgement processes, in which a first packet is transmitted but not successfully received by a receiving node (e.g., a negative acknowledgement message is received, or no acknowledgement message is received within a given time window or time frame). In those circumstances, the transmitting node may store data at one or more of steps 508, 512, 516, 520, 524, 528, 532, 536, and 540 while processing a transport block to generate the first (i.e. original) message for transmission. If a retransmission is required for any of the reasons given above, the stored data may be reused to generate a second message for the retransmission. Those skilled in the art will appreciate that the second message may not be a precise copy of the first message, but will in general comprise at least some of the data comprised in the first message. Latency in the transmission of the data is reduced as the second message can be processed more quickly than would otherwise be the case.

In another example, the method may be useful in communications systems, such as those implementing licensed assisted access (LAA), in which a “listen before talk” (also known as “listen before transmit”) condition applies. In those circumstances, a transmitting node must sense its radio environment (or a particular radio channel) to determine whether the radio environment or radio channel is available (i.e. no other node is transmitting), before transmitting. Thus, in those circumstances, the transmitting node may store data at one or more of steps 508, 512, 516, 520, 524, 528, 532, 536, and 540 while processing a transport block to generate a message for transmission, prior to the radio environment or radio channel becoming available (or prior to the node sensing the radio environment or radio channel for its availability). When the radio environment or radio channel is sensed by the node and determined as available, the node may reuse the stored data to generate and transmit the message. Latency in the transmission of data is reduced as the node can transmit the message more quickly once the radio environment or radio channel is determined as available.

It will further be noted from the disclosure above that the node may not store data at each of steps 508, 512, 516, 520, 524, 528, 532, 536, and 540. Rather, the node may store data at only a subset of steps 508, 512, 516, 520, 524, 528, 532, 536, and 540, or only one of steps 508, 512, 516, 520, 524, 528, 532, 536, and 540. In each case, however, the stored data will comprise data to which the scrambling algorithm has been applied (any to which one or more additional algorithms may also have been applied).

If data is stored at more than one of steps 508, 512, 516, 520, 524, 528, 532, 536, and 540, then the node may determine which of the sets of stored data to utilize for its transmission.

In one embodiment, the node may compare the circumstances at the time of processing the data to the circumstances at the time of the transmission (i.e. the transmission based on the stored data). If the circumstances are the same, such that each of the algorithms performed in steps 510, 514, 518, 522, 526, 530, 534 and 538 results in the same output, then the node may utilize whichever stored set of data has been processed the furthest using the method of FIG. 5, such that the fewest steps need to be taken to transmit the signal. If one or more of the circumstances is different, such that at least one of the algorithms results in a different output, then the node may utilize whichever stored data has been processed furthest using the method of FIG. 5 prior to that algorithm.

Take the example of a node executing a HARQ process. A transport block is processed according to the method of FIG. 5, and a first message is transmitted. We also assume that data is stored at each of the steps 508, 512, 516, 520, 524, 528, 532, 536, and 540.

The first message is not correctly received, and the node determines that a retransmission is required. For example, the node may receive a negative acknowledgement message, or no acknowledgement message, in respect of the first message. Thus a second message is required, comprising at least some of the data contained within the first message. If the circumstances for the second message are the same as for the first, the node may utilize the OFDM symbols stored in step 540 for the retransmission. Thus very little additional processing is required and the latency is low. However, the conditions for the second message may be different from the conditions for the first message. For example, say the node has fewer resources available to it for transmission of the second message than the first message. In that case, the rate-matching algorithm performed in step 514 will generate a different output for the second message than the first message. Thus the second message may be generated based on data which is stored in step 512 (i.e. prior to the rate-matching algorithm).

Note that data may not be stored in each of steps 508, 512, 516, 520, 524, 528, 532, 536, and 540. For example, in one embodiment data may be stored at step 508 but not step 512. Using the example above, where the available resources change as between the first message and the second message of a HARQ process, the node may therefore select data stored in step 508 in that case.

Those skilled in the art will appreciate that conditions for the second message may change in numerous different ways, resulting in any one or more of the algorithms carried out in FIG. 5 producing a different output.

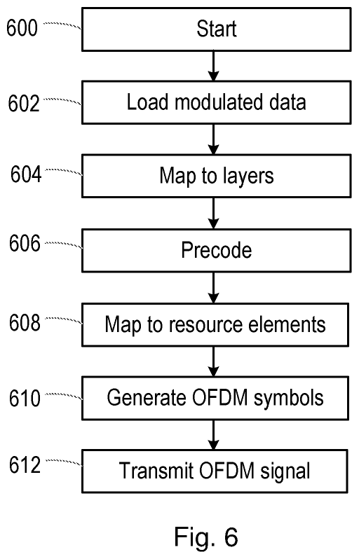

FIG. 6 is a flowchart showing an example of this method of processing according to embodiments of the disclosure. The method may be carried out in a node of a wireless communications network, such a wireless terminal device (i.e. when transmitting in uplink or sidelink), or a radio access node (i.e. when transmitting in downlink).

The node may implement a protocol stack comprising a plurality of layers. In such an embodiment, the method may be carried out in a physical or lowermost layer of the protocol stack.

The method may be carried out responsive to a determination to transmit a message. For example, the node may determine that a radio channel or radio environment is available for transmission, or that a retransmission is required in respect of a previous message that was not correctly received by a receiving node. Prior to that determination, the node has processed a transport block according to at least some of the steps of FIG. 5, and stored data corresponding to the processed data in at least one of steps 508, 512, 516, 520, 524, 528, 532, 536, and 540. In the example of FIG. 6, the data is stored at least in step 524, and thus corresponds to modulated data (i.e. data on which a modulation algorithm has been performed).

The method begins in step 600.

In step 602, the node loads the modulated data, stored in step 524, from the memory or other machine-readable medium which is accessible to it. In the following steps, the node applies the remaining steps required for processing and transmitting the message. Thus, the node maps the modulated data to layers in step 604; performs a precoding algorithm in step 606; maps the precoded data to resource elements in step 608; generates one or more OFDM symbols in step 610; and transmits the OFDM signal in step 612. Steps 604, 606, 608, 610 and 612 are therefore substantially the same as steps 526, 530, 534, 538 and 542 respectively.

Although not illustrated, the method of FIG. 6 may be carried out responsive to a determination that the circumstances at the time of performing the method of FIG. 6 are the same as the circumstances at the time of processing the data according to the method of FIG. 5; or that the circumstances are same at least until the modulation algorithm is performed. For example, the applicable modulation scheme may have changed between when the data was processed according to FIG. 5 (e.g. in respect of an original transmission, or pre-processed before transmission) and when the decision to transmit is taken in respect of FIG. 6 (e.g. in respect of a retransmission, or when a radio channel/environment becomes available).

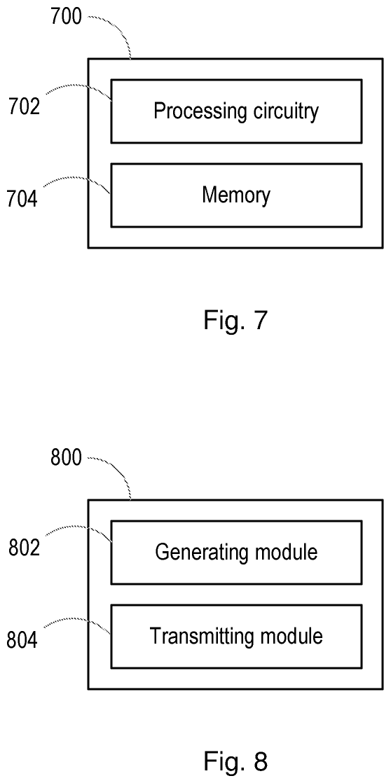

FIG. 7 is a schematic diagram of a node 700 according to embodiments of the disclosure. For example, the node 700 may be a wireless terminal device (i.e. a UE) or a radio access node (e.g. an eNodeB, a gNodeB, etc). The node 700 may be suitable for performing either or both of the methods described above with respect to FIGS. 5 and 6.

The terminal device 700 comprises processing circuitry 702 and a non-transitory machine-readable medium 704 (e.g. memory) storing instructions.

In one embodiment, the instructions are such that, when executed by the processing circuitry 702, they cause the terminal device to: process a block of data to generate a message for transmission by the node; and transmit the message. The node is caused to process the block of data by: performing a scrambling algorithm on data using a scrambling code; and subsequent to performing the scrambling algorithm, performing a rate-matching algorithm to match a number of bits for transmission to radio resources available to the node.

In another embodiment, the instructions are such that, when executed by the processing circuitry 702, they cause the terminal device to: generate a first message for transmission by the transmitting node; transmit the first message; responsive to a determination that a re-transmission is required in relation to the first message, generate a second message for transmission by the transmitting node; and transmit the second message. The node is caused to generate the first message by: performing a scrambling algorithm on data using a scrambling code; and storing data on which the scrambling algorithm has been performed. The node is caused to generate the second message by: generating the second message based on the stored data.

The terminal device 700 may also generally comprise hardware and/or software for transmitting and receiving wireless signals, such as one or more antennas, and transceiver circuitry coupled to the one or more antennas.

FIG. 8 is a schematic diagram of a node 800 according to further embodiments of the disclosure. For example, the node 800 may be a wireless terminal device (i.e. a UE) or a radio access node (e.g. an eNodeB, a gNodeB, etc). The node 800 may be suitable for performing either or both of the methods described above with respect to FIGS. 5 and 6.

The terminal device 800 comprises a generating or processing module 802 and a transmitting module 804.

In one embodiment, the generating or processing module 802 is configured to process a block of data to generate a message for transmission by the node. The transmitting module 804 is configured to transmit the message. The generating or processing module 802 is configured to process the block of data by: performing a scrambling algorithm on data using a scrambling code; and subsequent to performing the scrambling algorithm, performing a rate-matching algorithm to match a number of bits for transmission to radio resources available to the node.

In another embodiment, the generating or processing module 802 is configured to generate a first message for transmission by the transmitting node. The transmitting module 804 is configured to transmit the first message. The generating or processing module 802 is further configured to, responsive to a determination that a re-transmission is required in relation to the first message, generate a second message for transmission by the transmitting node. The transmitting module 804 is further configured to transmit the second message. The generating or processing module 802 is configured to generate the first message by: performing a scrambling algorithm on data using a scrambling code; and storing data on which the scrambling algorithm has been performed. The generating or processing module 802 is configured to generate the second message by: generating the second message based on the stored data.

The node 800 may also generally comprise hardware and/or modules for transmitting and receiving wireless signals, such as one or more antennas, and transceiver modules coupled to the one or more antennas.

Thus the disclosure provides methods, apparatus and machine-readable mediums according to which a scrambling algorithm is performed on data to be transmitted, prior to a rate-matching algorithm. The methods, apparatus and machine-readable mediums may allow data to be pre-processed—at least to the point where the scrambling algorithm has been performed—and stored, prior to a decision to transmit being taken. When a decision to transmit is taken (e.g. when a retransmission is required, or a radio channel or environment is determined as being available), the transmission may be based on the stored data, and fewer processing steps are required than would otherwise be the case. Thus latency in the transmission of data is reduced.

It should be noted that the above-mentioned embodiments illustrate rather than limit the concepts disclosed herein, and that those skilled in the art will be able to design many alternative embodiments without departing from the scope of the appended following statements. The word “comprising” does not exclude the presence of elements or steps other than those listed in a statement, “a” or “an” does not exclude a plurality, and a single processor or other unit may fulfil the functions of several units recited in the statements. Any reference signs in the statements shall not be construed so as to limit their scope.

1-34. (canceled)

35. A method in a transmitting node, the transmitting node operative in a wireless communications network, the method comprising:
processing a block of data to generate a message for transmission by the transmitting node; and
transmitting the message;
wherein processing the block of data comprises:
performing a scrambling algorithm on the data using a scrambling code; and
subsequent to performing the scrambling algorithm, performing a rate-matching algorithm to match a number of bits for transmission to radio resources available to the transmitting node.

36. The method according to claim 35, wherein processing the block of data further comprises:
storing the data on which the scrambling algorithm has been performed; and
responsive to a determination to transmit the message:
generating the message based on the stored data; and
transmitting the message.

37. The method according to claim 36, wherein the rate-matching algorithm is performed on the stored data as part of the step of generating the message.

38. The method according to claim 36, wherein the stored data comprises the data on which the scrambling algorithm and the rate-matching algorithm have been performed.

39. The method according to claim 36, further comprising making a determination to transmit the message upon determining that:
a previous message comprising at least some of the block of data was not successfully received by a receiving node; or
a radio channel is available for transmission by the transmitting node.

40. The method according to claim 35, wherein processing the block of data to generate the message further comprises:
prior to performing the rate-matching algorithm, performing a channel encoding algorithm on the data on which the scrambling algorithm has been performed.

41. The method according to claim 35, wherein processing the block of data to generate the message further comprises:
subsequent to performing the rate-matching algorithm, performing one or more of:
a modulating algorithm;
performing a layer-mapping algorithm to map the data to one or more layers for transmission by the transmitting node;
performing a precoding algorithm to precode the data for MIMO transmission by the transmitting node; and
generating one or more orthogonal frequency division multiplexing (OFDM) symbols.

42. The method according to claim 35, wherein the scrambling code is time-independent.

43. The method according to claim 42, wherein the time-independent scrambling code is initialized based on one or more time-independent parameters.

44. The method according to claim 42, wherein the time-independent parameters comprise one or more of: an identity of the transmitting node; an identity of a cell served by the transmitting node, or by which the transmitting node is served; a number of layers over which the message is transmitted; and an identifier associated with a physical channel over which the message is transmitted.

45. A node configured for operation in a wireless communications network, the node comprising:
processing circuitry; and
a machine-readable medium storing instructions which, when executed by the processing circuitry, cause the node to:
process a block of data to generate a message for transmission by the node; and
transmit the message;
wherein the node is caused to process the block of data by:
performing a scrambling algorithm on the data using a scrambling code; and
subsequent to performing the scrambling algorithm, performing a rate-matching algorithm to match a number of bits for transmission to radio resources available to the node.

46. The node according to claim 45, wherein the node is caused to process the block of data by:
storing the data on which the scrambling algorithm has been performed; and
responsive to a determination to transmit the message:
generating the message based on the stored data; and
transmitting the message.

47. The node according to claim 46, wherein the rate-matching algorithm is performed on the stored data as part of the step of generating the message.

48. The node according to claim 46, wherein the node is caused to make a determination to transmit the message upon determining that:
a previous message comprising at least some of the block of data was not successfully received by a receiving node; or
a radio channel is available for transmission by the transmitting node.

49. The node according to claim 45, wherein the node is caused to process the block of data to generate the message by:
prior to performing the rate-matching algorithm, performing a channel encoding algorithm on the data on which the scrambling algorithm has been performed.

50. The node according to claim 45, wherein the node is caused to process the block of data to generate the message by:
subsequent to performing the rate-matching algorithm, performing one or more of:
a modulating algorithm;
performing a layer-mapping algorithm to map data to one or more layers for transmission by the node;
performing a precoding algorithm to precode data for MIMO transmission by the node;
performing a resource element mapping algorithm to map data to one or more resource elements for transmission by the node; and
generating one or more orthogonal frequency division multiplexing (OFDM) symbols.

51. The node according to claim 45, wherein the scrambling code is time-independent.

52. The node according to claim 51, wherein the time-independent scrambling code is initialized based on one or more time-independent parameters.

53. The node according to claim 52, wherein the time-independent parameters comprise one or more of: an identity of the node; an identity of a cell served by the transmitting node, or by which the transmitting node is served; a number of layers over which the message is transmitted; and an identifier associated with a physical channel over which the message is transmitted.

54. The node according to claim 45, wherein the node is one of: a radio access node and a wireless terminal device.
